(19) United States
(12) Patent Application Publication
(10) Pub. No.: US 2024/0428457 A1
(43) Pub. Date: Dec. 26, 2024

(54) Camera Calibration for Robotic Arrayed Inkjet Printing

(71) Applicant: The Boeing Company, Arlington, VA (US)

(72) Inventors: Willaredt Hardy, San Francisco, CA (US); Anthony W. Baker, Gilbertsville, PA (US); Philip Lawrence Freeman, Summerville, SC (US)

(21) Appl. No.: 18/338,553

(22) Filed: Jun. 21, 2023

(51) Int. Cl. G06T 7/80; B41J 29/393; G06T 7/62; G06T 7/73

(52) U.S. Cl. CPC G06T 7/80; B41J 3/4073; B41J 29/393; G06T 7/62; G06T 7/73; B41J 2203/01

(57) ABSTRACT

The present application is directed for use with a printhead assembly that is mounted to a robot. One application provides a system for inkjet printing on large objects such as commercial aircraft surfaces. The application provides for calibrating a camera with relation to the motion of the robot. The calibration occurs is achieved using one or more calibration artifacts printed by the inkjet system.

### TECHNOLOGICAL FIELD

The present disclosure relates generally to the field of inkjet printing and, more specifically, to camera calibration for use in detecting errors with inkjet printing.

### BACKGROUND

Inkjet printing equipment can be configured for printing on large surfaces. Printing contexts include but are not limited printing on various aircraft components, such as a commercial aircraft fuselage, wings, and flight control members. Other contexts include but are not limited to large equipment components (e.g., frames, work beds) and industrial machinery.

The inkjet printing equipment includes an inkjet printhead assembly mounted on a robot. In one example, the printhead assembly includes a printhead housing that has a number of separate printheads. Each inkjet printhead dispenses a different color ink, such as cyan, yellow, magenta and black. The printheads are controlled as the robot moves the printhead assembly across the surface during the printing.

An issue with large scale inkjet printing is the need for large robots that are sized to extend across a portion or entirety of the printed surfaces. The printhead assembly is mounted at the end of the robot and experiences high dynamic loads as a result of the size. Inkjet printing allows very low error tolerance in ink application before visible defects occur. Cameras are used to monitor the inkjet printing and detect the visible errors. The cameras should be calibrated to provide for the localized, low latency visual monitoring to minimize visible printing defects. The cameras should be configured to identify various errors in the inkjet printing such as but not limited to nozzle outages and motion system errors between overlapping passes of ink application.

### SUMMARY

One aspect is directed to a method of calibrating a camera for use with robotic inkjet printing. The method comprises: printing a calibration artifact that comprises one or more control points with the calibration artifact printed with a printhead assembly that is coupled to a robot and the calibration artifact is printed on an object at a known position; moving with the robot a camera that is coupled to the printhead assembly and capturing image data of the calibration artifact; detecting the calibration artifact from the image data; determining a detected position of the calibration artifact based on a location of the robot when the image data is captured; and calibrating the camera based on the known position of the calibration artifact and the detected position of the calibration artifact.

In another aspect, the calibration artifact comprises one or more control points that are located at known control point positions with the method further comprising: determining detected positions of the control points from the image data captured by the camera; and calibrating the camera based on the known control point positions of the calibration artifact and the detected positions of the control points of the calibration artifact.

In another aspect, the method further comprises creating scan paths for the robot to move the printhead assembly over the object and capturing the image data of the calibration artifact while the robot is moving the printhead assembly along the scan paths.

In another aspect, the method further comprises capturing three-dimensional scans of a surface of the object with a metrology system prior to printing the calibration artifact at the known position.

In another aspect, the method further comprises determining the movement of the robot in a metrology coordinate system that is based on the three-dimensional scans of the object.

In another aspect, the method further comprises determining the location of the robot based on a tool center point of the printhead assembly.

In another aspect, the method further comprises calibrating the camera based on a known distance on the printhead assembly between the tool center point and the camera.

In another aspect, the calibration artifact is a first calibration artifact and the method further comprises: printing additional calibration artifacts on the object at known positions; capturing additional image data of the additional calibration artifacts; and calibrating the camera with respect to the robot based on a difference between the known positions of the calibration artifacts and the tool center point when the image data of the calibration artifacts was captured.

In another aspect, capturing the image data of the calibration artifact comprises capturing the image data with a line scan camera.

One aspect is directed to a method of calibrating a camera for use with robotic inkjet printing. The method comprises: determining dimensions of an object within a coordinate system that is based on three dimensional scans of the object by a metrology system; printing a calibration artifact on the object with a printhead assembly that is coupled to a robot with the calibration artifact printed at a known position on the object within the coordinate system; monitoring movement of the robot within the coordinate system while the robot is moving over the object; moving a camera with the robot over the object and capturing image data of the calibration artifact; determining a location of a tool center point of the printhead assembly when the image data of the calibration artifact was captured based on a location of the robot when the image data was captured by the camera; and calibrating the camera with respect to the robot based on a difference between the known position of the calibration artifact and the tool center point when the image data of the calibration artifact was captured.

In another aspect, the method further comprises calibrating the robot within the coordinate system of the metrology system prior to printing the calibration artifact on the object.

In another aspect, the method further comprises designing the calibration artifact and including one or more control points within the calibration artifact.

In another aspect, the calibration artifact is a first calibration artifact and the method further comprises: printing additional calibration artifacts on the object at known positions; capturing image data of the additional calibration artifacts; and calibrating the camera with respect to the robot based on a difference between the known positions of the calibration artifact and the tool center point when the image data of the calibration artifacts was captured.

In another aspect, calibrating the camera with respect to the robot comprises factoring a known distance between the tool center point and a position of the camera on the printhead assembly.

One aspect is directed to an inkjet printing system to print on an object. The inkjet printing system comprises: a printhead assembly comprising a plurality of inkjet printheads with the printhead assembly configured to be mounted to a robot. A control unit is operatively connected to the printhead assembly and the robot to move the printhead assembly relative to the object. The control unit comprises processing circuitry configured to: print a calibration artifact that comprises one or more control points at a known position; operate the robot and move a camera that is coupled to the printhead assembly over the object and capture image data of the calibration artifact; detect the calibration artifact from the image data; determine a detected position of the calibration artifact based on a location of the robot when the image data is captured; and calibrate the camera based on the known position of the calibration artifact and the detected position of the calibration artifact.

In another aspect, the control unit is configured to monitor a position of the printhead assembly based on a tool center point of the printhead assembly.

In another aspect, the control unit is configured to determine the detected position of the calibration artifact based on a known distance between the camera and a tool center point of the printhead assembly.

In another aspect, a metrology system determines a three dimensional shape of the object.

In another aspect, the control unit is configured to determine the calibration artifact based on a series of calibration artifacts that are stored in memory circuitry.

In another aspect, a user interface comprises an input device and a display with the user interface configured to send signals to the processing circuitry to control an aspect of the calibration of the camera.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a perspective view of an object and a metrology system and control unit configured to measure the object and calibrate a camera.

FIG. 2 is schematic diagram of a printhead assembly coupled to a robot for inkjet printing of an object.

FIG. 3 is a perspective view of a printhead assembly.

FIG. 4A is a schematic diagram of a calibration artifact.

FIG. 4B is a schematic diagram of a calibration artifact.

FIG. 5 is a flowchart diagram of a method of calibrating a camera with respect to a robot.

FIG. 6 is a flowchart diagram of a method of calibrating a camera with respect to a robot.

FIG. 7 is a flowchart diagram of a method of calibrating a camera with respect to a robot.

FIG. 8 is a schematic diagram of a control unit that controls operation of the calibration of a camera.

### DETAILED DESCRIPTION

The present application provides a system for inkjet printing, particularly for printing on large objects, such as commercial aircraft surfaces. The application provides for calibrating one or more cameras that are coupled to the printhead assembly with relation to the motion of a co-mounted robotic inkjet system through the use of one or more calibration artifacts printed by the inkjet system.

The application provides a methodology for the measurement of camera intrinsics, extrinsics, and ink color recognition as it relates to an inkjet printhead mounted on a robot through application and identification of one or more calibration artifacts at locations known in the coordinate frame of the overall robotic motion. In some examples, calibration artifacts are printed on an object and include one or more control points at precisely known locations within the coordinate system of motion for the targeted robotic inkjet system. This placement significantly reduces the degree of error in the determination of the relation between the extrinsic coordinate systems of a camera and a robotic inkjet end-effector. This calibration supports accurate, low latency inkjet printing defect detection and rectification processes by localizing cameras relative to the robotic inkjet system, providing means to localize defects identified in line scan imagery and support targeted rectification procedures.

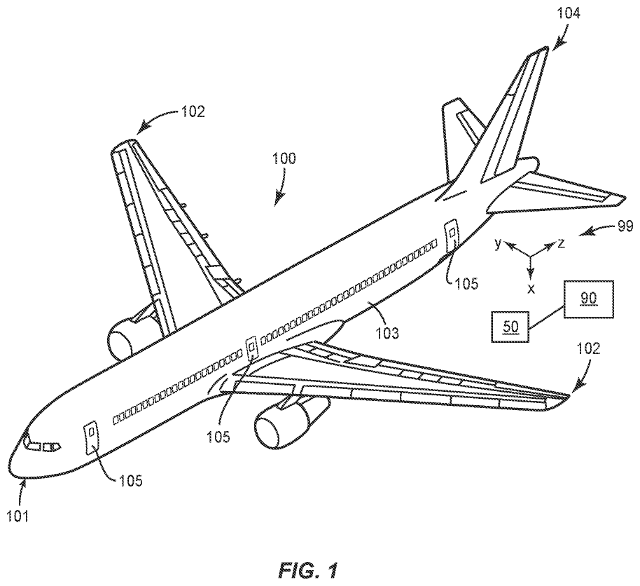

The inkjet printing systems and method can be used for printing on a variety of different objects 100. FIG. 1 illustrates one example of an object 100 that includes a commercial aircraft. In some examples, the printing occurs after the object has been assembled such as the assembled aircraft of FIG. 1. In other examples, the printing occurs on objects 100 consisting of smaller components that may (or may not) be subsequently assembled into a larger assemblies. Using an aircraft assembly, examples of smaller objects 100 that are printed then subsequently assembled include but are not limited to vertical and horizontal stabilizers, engine housings, and portions of a fuselage.

A metrology system 50 measures the dimensions of the object 100. The metrology system 50 includes one or more instruments to take measurements of the object 100. In some examples, a metrology system 50 includes one or more laser trackers that accurately measures the object 100 by determining the positions of one or more optical points and/or artifacts on the object 100. In some examples, the metrology system 50 includes a coordinate measuring machine (CMM) that measures the geometry of the object 100 by sensing discrete points on the surface with a probe. In metrology systems 50 with two or more instruments, the instruments may be the same or different. In some examples, the metrology system 50 includes a control unit with computer processing capabilities to determine the dimensions. Additionally or alternatively, the metrology system 50 is operatively connected to a control unit 90 that oversees the calibration process.

The measurements of the metrology system 50 are used to establish a coordinate system 99 to identify locations on the object 100. This coordinate system 99 is used by the control unit 90 during calibration of the camera 30, inkjet printing of the object 100, and/or movement of the robot 40.

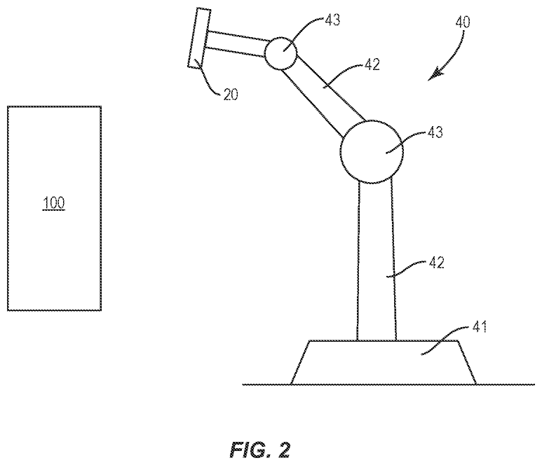

FIG. 2 illustrates a robot 40 configured to move the inkjet printhead assembly 20 during printing of the object 100. The robot 40 includes a base 41 that supports one or more linkages 42. The base 41 can be configured to be positioned at a fixed location or can include wheels or otherwise be movable relative to the object 100. Articulating joints 43 provide for relative movement between the linkages 42 and/or the inkjet printhead assembly 20. The size, shape, and movement capabilities of the robot 40 can vary depending upon the needs of the print job.

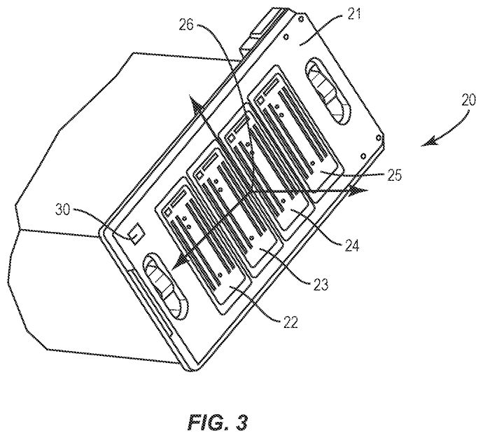

The printhead assembly 20 is mounted at the end of the robot 40. FIG. 3 illustrates the printhead assembly 20 in greater detail. The printhead assembly 20 includes a housing 21. Inkjet printheads 22, 23, 24, 25 are mounted in the housing 21 and each is configured to discharge a different color ink to produce a full color palette that may be used in the printing. In some examples, the printheads include a cyan printhead 22, a yellow printhead 23, a magenta printhead 24 and a black printhead 25. This is a typical printhead arrangement where the printhead assembly 20 will pass over the object 100 in a normal print direction with the cyan printhead 22 at a leading end followed by the yellow printhead 23, the magenta printhead 24 and the black printhead 25 at a trailing end to discharge ink in color sequences to produce the colors of the pattern in a manner known in the art. Alternative color sequences and/or alternative base colors may be used depending on a particular implementation of the printhead assembly 20 in accordance with the present disclosure. The printhead assembly 20 includes a tool center point (TCP) 26. The TCP 26 serves as an origin that is used to determine the position of the printhead assembly 20 in the coordinate system 99.

During printing, the robot 40 moves the printhead assembly 20 in various manners including along one or more axes. One type of movement is along a first axis (e.g., an X-axis) that corresponds to the side-to-side movement of the housing 21 in the print direction. The positive X direction is in the direction of the printheads 22, 23, 24, 25 moving in a single file line with the cyan printhead 22 passing over the object first. A second axis (e.g., a Y-axis) is in the up-and-down direction of movement of the printhead assembly 20. A third axis (e.g., a Z-axis) represents movement of the printhead assembly 20 toward and away from the object 100 normal to the surface of the object 100 that is being printed. The robot 40 is further able to rotate the printhead assembly 20 in various manners and with various rotational degrees of freedom including roll, pitch, and yaw.

One or more cameras 30 are mounted to the printhead assembly 20 to capture images from the object 100. Various types of cameras 30 can be used to capture the image data. In some examples, the camera 30 includes a single sensor element that is configured to produce two-dimensional images. One example is a line scan camera 30 that captures one row of pixels at a time as the printhead assembly 20 is passed over the object 100. The line scan camera 30 is positioned on the printhead assembly 20 at a known location relative to the TCP 26. This position is used during calibration of the camera 30 as will be explained in more detail below. FIG. 3 includes an example with a single camera 30 coupled to the printhead assembly 20. In other examples, two or more cameras 30 are coupled to the printhead assembly 20. In these examples, the cameras 29 may be the same or different.

The control unit 90 controls the robot 40 to move the printhead assembly 20 along the various directions and rotations to print on the object 100. In some examples, the control unit 90 uses a position on the printhead assembly 20 to monitor the movement. In one example, the control unit 90 uses the TCP 26. The TCP 26 provides for a base reference point when determining the position. In other examples, the control unit 90 tracks a different point when monitoring the location of the printhead assembly 20. In the various examples, the position that is used to monitor the movement of the printhead assembly 20 is located at a known position from the camera 30. The known position is a known distance from the camera 30.

During the inkjet printing process, the control unit 90 monitors the object 100 for visible printing defects. To provide for accurate monitoring, the camera 30 is calibrated with respect to the motion of the robot 40. The calibration process uses one or more calibration artifacts 60 that are printed on the object 100 by the printhead assembly 20. The calibration artifacts 60 are located at known positions within the coordinate system 99. After printing, the robot 40 moves the camera 30 over the object to detect the one or more artifacts 60. The one or more detected positions based on the captured image data is compared to the one or more known locations to calibrate the camera 30.

The calibration artifacts 60 are configured to be printed on the object 100 by the printhead assembly 20. The number of calibration artifacts 60 used during the calibration can vary from a single calibration artifact 60 to multiple calibration artifacts 60. When multiple calibration artifacts 60 are used, the calibration artifacts 60 may be the same or different.

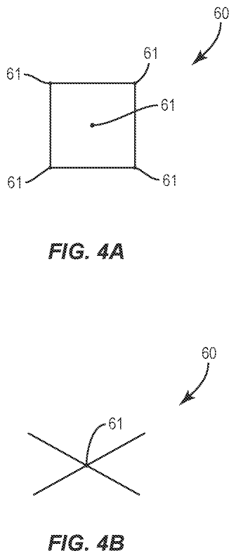

The calibration artifacts 60 include one or more control points 61. The control points 61 are specific, identifiable points on the calibration artifacts 60 that can be detected during analysis of the image data captured by the camera 30. The calibration artifacts 60 with the control points 61 can vary depending upon the testing and range from robust pixel offsets to minor pixel offsets. FIG. 4A illustrates an example of a calibration artifact 60 that includes a rectangular box. Control points 61 are located at one or more of the corners and a center point. FIG. 4B illustrates another calibration artifact 60 that includes a pair of straight lines. A control point 61 is located at an intersection of the lines. The calibration artifacts 60 can be printed in various colors within color gamuts of the printheads 22, 23, 24, 25. The calibration artifacts 60 provide for calibrating one or more of alignment and color recognition.

The methods can be implemented using any number of different forms of calibration artifacts 60. In some examples, the calibration incorporates elements of ink color gamut to perceived ink color calibration.

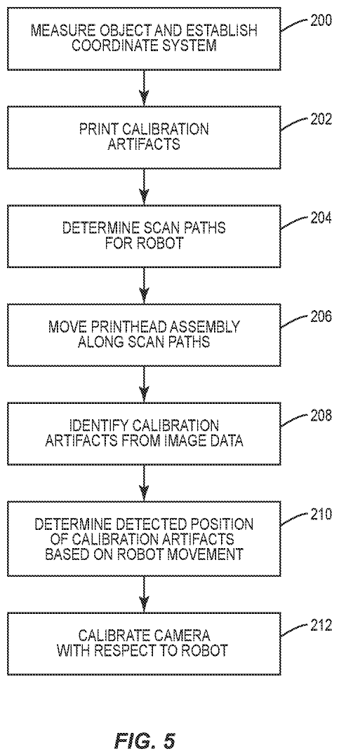

FIG. 5 illustrates a method of calibrating a camera 30 relative to the robot 40 used to move the printhead assembly 20. The metrology system 50 measures the object 100 and establishes a coordinate system 99 (block 200). In some examples, this includes collecting 3D scans of the surface of the object 100 using a metrology system 50 having one or more metrology instruments.

One or more calibration artifacts 60 are printed on the object 100 with the printhead assembly 20 (block 202). In some examples, this includes moving the printhead assembly 20 over the object 100 using the robot 40. The printhead assembly 20 prints the one or more calibration artifacts 60 at known positions on the object 100. In some examples, the locations are determined by the metrology system 50 after the calibration artifacts 60 are printed on the object 100. The one or more metrology instruments scan the object 100 and detect the position on the object 100. In some examples, the calibration artifacts 60 are printed at specific, detectable points on the object 100. Examples include but are not limited to intersections of the wings and fuselage of an aircraft and at a tip of the wing.

After the calibration artifacts 60 are printed on the object 100, scan paths are developed that will move the printhead assembly 20 along the object 100 and over the calibration artifacts 60 (block 204). The scan paths provide for the robot 40 to move the camera 30 over the calibration artifacts 60 so they can be captured by the camera 30. The number and configuration of the scan paths can vary provided that the camera 30 is able to capture the calibration artifacts 60 during the movement.

After the calibration artifacts 60 are printed and the scan paths are established, the robot 40 moves the printhead assembly 20 along the scan paths (block 206). The robot 40 moves the printhead assembly 20 over the object 100 at varying attitudes and depths with minimal angular deflection along each trajectory. During the movement, the control unit 90 monitors the movement of the robot 40 and the location of the printhead assembly 20. The location information is referenced in the coordinate system 99 established by the metrology system 50. In some examples, the location of the printhead assembly 20 is based on the TCP 26. In addition to the location, the control unit 90 monitors the timing of the movement of the robot 40 and printhead assembly 20. Thus, the control unit 90 monitors the location and time at which the printhead assembly 20 moves over various points on the object 100 including over the calibration artifacts 60.

The camera 30 captures image data including of the calibration artifacts 60 as the printhead assembly 20 moves over the object 100. In some examples, the camera 30 continuously captures image data of the object 100. In some examples, the camera 30 periodically captures image data, such as recording image data at various frequencies as the camera 30 is moved across the object 100. The corresponding time at which the image data is captured is also associated with the image data.

The control unit 90 receives the image data and identifies the calibration artifacts 60 (block 208). In some examples, the identification includes determining the one or more control points 61 of the calibration artifacts 60.

The control unit 90 determines a detected position of the calibration artifacts 60 based on the movement of the robot 40 (block 210). The detected position is determined by corresponding the location of the printhead assembly 20 at the time of the calibration artifact 60 is captured in the image data by the camera 30. For example, if a calibration artifact 60 is captured in an image frame that was taken at time X, the control unit 90 determines the position of the printhead assembly 20 at time X. The position of the calibration artifact 60 is then equated to the position of the printhead assembly 20 at that time. In some examples, this includes the time at which the control point 61 is captured in the image data. In some examples, the position of the printhead assembly 20 is equated to the position of the TCP 26.

In some examples, the detected position further includes accounting for the offset distance on the printhead assembly 20 between the TCP 26 and the camera 30. In some examples, this is necessary when the control unit 90 equates the position of the camera 30 to the TCP 26. In one example, the control unit 90 selects one or more frames from the image data. For each of the frames, the control unit 90 initially determines the position of the camera 30 as being equal to the TCP 26. The control unit 90 then accounts for the offset distance between the TCP 26 and the camera 30 to determine the detected position of the calibration artifact 60.

The camera 30 is then calibrated based on the known position of the calibration artifacts 60 and the detected positions of the calibration artifacts 60 (block 212). The difference between the two positions provides for the control unit 90 to calibrate the camera 30 with respect to the robot 40.

In some examples, the calibration of the camera 30 uses traditional optimization methods to determine the camera parameters. The calibration parameters can include one or more intrinsic parameters and/or extrinsic parameters. In some examples, the control unit 90 can determine an overall alignment of the printhead assembly 20, alignment of each individual printhead 22, 23, 24, 25, operation of each individual printhead 22, 23, 24, 25 (e.g., is the printhead working properly), and various color gamut aspects.

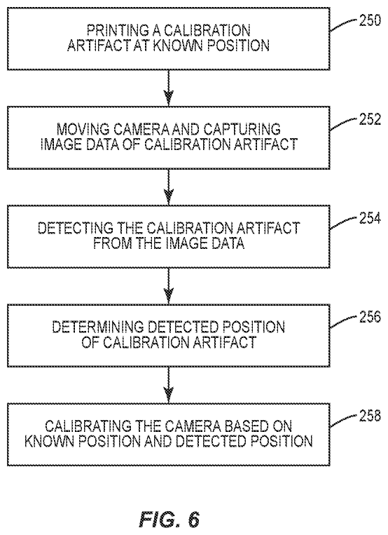

FIG. 6 illustrates another method of calibrating a camera 30 for use with robotic inkjet printing. The method includes printing a calibration artifact 60 that has one or more control points 61 (block 250). The calibration artifact 60 is printed with a printhead assembly 20 that is coupled to a robot 40. The calibration artifact 60 is printed on an object 100 at a known position. A camera 30 that is coupled to the printhead assembly 20 is moved with the robot 40 (block 252). The camera 30 captures image data of the calibration artifact 60.

The image data is analyzed and the calibration artifact 60 is detected (block 254). A detected position of the calibration artifact 60 is determined based on a location of the robot 40 when the image data is captured (block 256). The camera 30 is calibrated based on the known position of the calibration artifact 60 and the detected position of the calibration artifact 60 (block 258).

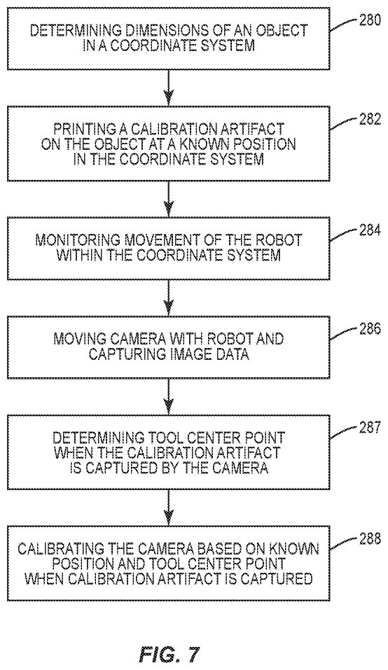

FIG. 7 illustrates a method of calibrating a camera 30 for use with robotic inkjet printing. The method includes determining dimensions of an object 100 within a coordinate system 99 that is based on three dimensional scans of the object 100 by a metrology system 50 (block 280). A calibration artifact 60 is printed on the object 100 with a printhead assembly 20 that is coupled to a robot 40 (block 282). The calibration artifact 60 is printed at a known position on the object 100 within the coordinate system 99.

The location of the robot 40 is monitored within the coordinate system 99 as the robot 40 moves over the object 100 (block 284). A camera 30 that is coupled to the robot 40 is moved over the object 100 and captures image data including the calibration artifact 60 (block 286). A location of a tool center point 26 is determined for when the image data of the calibration artifact 60 was captured (block 287). The location is based on a location of the robot 40 when the image data was captured by the camera 30. The camera 30 is calibrated with respect to the robot 40 based on a difference between the known position of the calibration artifact 60 and the tool center point 26 when the image data of the calibration artifact 60 was captured (block 288).

In some examples, the printhead assembly 20 includes a single camera 30 that captures the image data. In other examples, the printhead assembly 20 includes two or more cameras 30 that each capture image data. The locations of the cameras 30 are tracked and the image data captured by the cameras 30 are analyzed as described above. The detected position of the calibration artifact 60 is determined based on the image data from one or more of the different cameras 30.

In some examples, the calibration process is performed by a control unit 90. In some examples, the control unit 90 is coupled to the printhead assembly 20 and/or robot 40. In other examples, the control unit 90 is located remotely away from the robot 40 and printhead assembly 20.

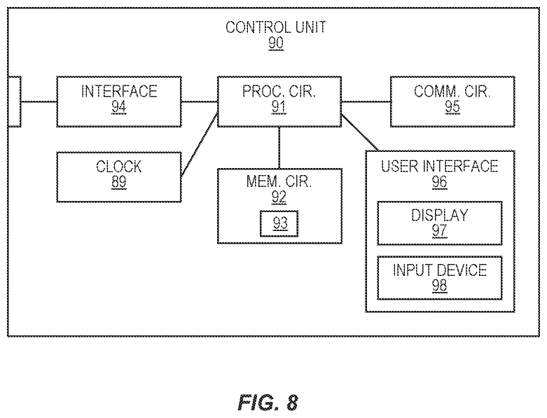

As illustrated in FIG. 8, the control unit 90 includes processing circuitry 91 that operates according to program instructions 93 stored in memory circuitry 92. The processing circuitry 91 includes one or more circuits, microcontrollers, microprocessors, hardware, or a combination thereof. The processing circuitry 91 can include various amounts of computing power to provide for the needed functionality.

Memory circuitry 92 includes a non-transitory computer readable storage medium storing program instructions 93, such as a computer program product, that configures the processing circuitry 91 to implement one or more of the techniques discussed herein. Memory circuitry 92 can include various memory devices such as, for example, read-only memory, and flash memory. Memory circuitry 92 can be a separate component as illustrated in FIG. 8 or can be incorporated with the processing circuitry 91. Alternatively, the processing circuitry 91 can omit the memory circuitry 92, e.g., according to at least some embodiments in which the processing circuitry 91 is dedicated and non-programmable.

Interface circuitry 94 provides for sending and/or receiving signals from one or more of the components of the system. Components include but are not limited to the robot 40, printhead assembly 20, and camera 30. The interface circuitry 94 can provide for one-way communications or two-way communications that are both to and from the components.

Communication circuitry 95 provides for communications to and from the control unit 90 with a remote node (e.g., operator equipment, server, database). Communications circuitry 95 provides for sending and receiving data with one or more remote nodes. A clock 89 is used to tracking the timing of movement of the robot 40 and/or printhead assembly 20.

A user interface 96 provides for a user to control one or more aspects of the system during operation. The user interface 96 includes one or more input devices 98 such as but not limited to a keypad, touchpad, roller ball, and joystick. The user interface 96 also includes one or more displays 97 for displaying information regarding the testing and/or for an operator to enter commands to the processing circuitry 91.

In some examples, the control unit 90 controls the full operation of the calibration system. Additionally or alternatively, one or more of the components can be controlled by a user.

The present application accounts for issues with inkjet printing, particularly large scale inkjet printing that uses large robots 40 that are sized to extend across a portion or entirety of an object 100. The present application addresses issues with inkjet printing including the very low error tolerance in ink application before visible defects occur. The one or more cameras 30 monitor the inkjet printing and detect the visible errors. The calibration of the cameras 30 provides for the localized, low latency visual monitoring to minimize visible printing defects. The cameras 30 are configured to identify various errors in the inkjet printing such as but not limited to nozzle outages and motion system errors between overlapping passes of ink application.

In some examples, multiple different calibration artifacts 60 are stored in the memory circuitry 92. Each of the calibration artifacts 60 is applicable for detecting a different aspect of the camera calibration. The control unit 90 determines the one or more calibration artifacts 60 that are printed on the object 100 based on a desired aspect of the camera calibration. In one example, the control unit 90 receives input from a user regarding the aspect of the calibration and prints the applicable one or more calibration artifacts 60 based on the input.

The present invention may be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of calibrating a camera for use with robotic inkjet printing, the method comprising:
printing a calibration artifact that comprises one or more control points, the calibration artifact printed with a printhead assembly that is coupled to a robot and the calibration artifact is printed on an object at a known position;
moving with the robot a camera that is coupled to the printhead assembly and capturing image data of the calibration artifact;
detecting the calibration artifact from the image data;
determining a detected position of the calibration artifact based on a location of the robot when the image data is captured; and
calibrating the camera based on the known position of the calibration artifact and the detected position of the calibration artifact.

2. The method of claim 1, wherein the calibration artifact comprises one or more control points that are located at known control point positions, the method further comprising:
determining detected positions of the control points from the image data captured by the camera; and
calibrating the camera based on the positions of the control points of the calibration artifact and the detected positions of the control points of the calibration artifact.

3. The method of claim 1, further comprising creating scan paths for the robot to move the printhead assembly over the object and capturing the image data of the calibration artifact while the robot is moving the printhead assembly along the scan paths.

4. The method of claim 1, further comprising capturing three-dimensional scans of a surface of the object with a metrology system prior to printing the calibration artifact at the known position.

5. The method of claim 1, further comprising determining the movement of the robot in a metrology coordinate system that is based on the three-dimensional scans of the object.

6. The method of claim 1, further comprising determining the location of the robot based on a tool center point of the printhead assembly.

7. The method of claim 6, further comprising calibrating the camera based on a known distance on the printhead assembly between the tool center point and the camera.

8. The method of claim 1, wherein the calibration artifact is a first calibration artifact, the method further comprising:
printing additional calibration artifacts on the object at known positions;
capturing additional image data of the additional calibration artifacts; and
calibrating the camera with respect to the robot based on a difference between the known positions of the calibration artifacts and the tool center point when the image data of the calibration artifacts was captured.

9. The method of claim 1, wherein capturing the image data of the calibration artifact comprises capturing the image data with a line scan camera.

10. A method of calibrating a camera for use with robotic inkjet printing, the method comprising:
determining dimensions of an object within a coordinate system that is based on three dimensional scans of the object by a metrology system;
printing a calibration artifact on the object with a printhead assembly that is coupled to a robot, the calibration artifact printed at a known position on the object within the coordinate system;
monitoring movement of the robot within the coordinate system while the robot is moving over the object;
moving a camera with the robot over the object and capturing image data of the calibration artifact;
determining a location of a tool center point of the printhead assembly when the image data of the calibration artifact was captured based on a location of the robot when the image data was captured by the camera; and
calibrating the camera with respect to the robot based on a difference between the known position of the calibration artifact and the tool center point when the image data of the calibration artifact was captured.

11. The method of claim 10, further comprising calibrating the robot within the coordinate system of the metrology system prior to printing the calibration artifact on the object.

12. The method of claim 10, further comprising designing the calibration artifact and including one or more control points within the calibration artifact.

13. The method of claim 10, wherein the calibration artifact is a first calibration artifact, the method further comprising:
printing additional calibration artifacts on the object at known positions;
capturing image data of the additional calibration artifacts; and
calibrating the camera with respect to the robot based on a difference between the known positions of the calibration artifacts and the tool center point when the image data of the calibration artifacts was captured.

14. The method of claim 13, wherein calibrating the camera with respect to the robot comprises factoring a known distance between the tool center point and a position of the camera on the printhead assembly.

15. An inkjet printing system to print on an object, the inkjet printing system comprising:
a printhead assembly comprising a plurality of inkjet printheads, the printhead assembly configured to be mounted to a robot;
a control unit operatively connected to the printhead assembly and the robot to move the printhead assembly relative to the object, the control unit comprising processing circuitry configured to:
print a calibration artifact that comprises one or more control points at a known position;
operate the robot and move a camera that is coupled to the printhead assembly over the object and capture image data of the calibration artifact;
detect the calibration artifact from the image data;
determine a detected position of the calibration artifact based on a location of the robot when the image data is captured; and
calibrate the camera based on the known position of the calibration artifact and the detected position of the calibration artifact.

16. The inkjet printing system of claim 15, further comprising the control unit configured to monitor a position of the printhead assembly based on a tool center point of the printhead assembly.

17. The inkjet printing system of claim 15, further comprising the control unit configured to determine the detected position of the calibration artifact based on a known distance between the camera and a tool center point of the printhead assembly.

18. The inkjet printing system of claim 15, further comprising a metrology system that determines a three dimensional shape of the object.

19. The inkjet printing system of claim 15, further comprising the control unit configured to determine the calibration artifact based on a series of calibration artifacts that are stored in memory circuitry.

20. The inkjet printing system of claim 15, further comprising a user interface comprising an input device and a display, the user interface configured to send signals to the processing circuitry to control an aspect of the calibration of the camera.
